(19) United States
(12) Patent Application Publication
(10) Pub. No.: US 2011/0180508 A1
(43) Pub. Date: Jul. 28, 2011

(54) DUAL OPENING NURSING BOTTLE

(76) Inventor: CHIN-LONG FONG, TAIPEI COUNTY (TW)

(21) Appl. No.: 12/692,885

(22) Filed: Jan. 25, 2010

(51) Int. Cl. A61J 9/04; A61J 9/08

(52) U.S. Cl. 215/11.5; 215/11.6

(57) ABSTRACT

A dual opening nursing bottle includes a bottle body having a top opening and a bottom opening, a nipple attached to the top opening of the bottle body, a top cap fastened to the top opening of the bottle body to hold down the nipple in place, a bottom cap fastened to the bottom opening of the bottle body and having a center through hole, a pad detachably mounted inside the bottom cap to seal the bottom opening of the bottle body, and a one-way air valve installed in the pad for allowing outside air to be sucked into the inside of the bottle body and prohibiting the contained fluid from flowing out of the bottom body through the bottom opening.

### BACKGROUND OF THE INVENTION

1. Field of the Invention

The present invention relates to nursing bottles and more particularly, to a dual opening nursing bottle, which facilitates the baby's suction action and cleaning of the component parts.

2. Description of the Related Art

A conventional nursing bottle, as shown in FIGS. 13 and 14, comprises a bottle body 6 having a bottleneck 60, a nipple 62 attached to the bottleneck 60 and suspending outside of the bottle body 6 and a cap 61 fastened to the bottleneck 60 to hold down the nipple 62 in place. The nipple 62 has a front tip end 64, a rear base end 63, a split 641 formed in the front tip end 64, air holes 631 formed in the rear base end 63, air grooves 632 respectively extended from the air holes 631 and a locating groove 621 located on the connection area between the front tip end 64 and the rear base end 63 for the positioning of the cap 61. The air holes 631 may be opened in factory. Alternatively, the air holes 631 may be closed in factory and selectively opened by the consumer.

When the baby sucks on the front tip end 64 of the nipple 62, outside air is drawn through the air grooves 632 and the air holes 631 into the inside of the bottle body 6 so that the baby can suck in the contained fluid out of the bottle body 6. When the baby releases the mouth from the front tip end 64 of the nipple 62, the elastic material property of the nipple 62 causes the front tip end 64 to close the split 641 and the air holes 631. However, if the air holes 631 are opened by the consumer with a piercing member, the air holes 631 may be not equal in size, causing the baby unable to suck in the contained fluid from the bottle body 6 smoothly. Further, because the bottle body 6 has only one opening defining in the bottleneck 60, it is difficult to clean the inside of the bottle body 6 thoroughly.

### SUMMARY OF THE INVENTION

The present invention has been accomplished under the circumstances in view. It is one object of the present invention to provide a dual opening nursing bottle, which facilitates the baby's suction action and cleaning of the component parts.

To achieve this and other objects of the present invention, a dual opening nursing bottle comprises a bottle body having a top opening and a bottom opening, a nipple attached to the top opening of the bottle body, a top cap fastened to the top opening of the bottle body to hold down the nipple in place, a bottom cap fastened to the bottom opening of the bottle body and having a center through hole, a pad detachably mounted inside the bottom cap to seal the bottom opening of the bottle body, and a one-way air valve installed in the pad for allowing outside air to be sucked into the inside of the bottle body and prohibiting the contained fluid from flowing out of the bottom body through the bottom opening.

To achieve this and other objects of the present invention, a dual opening nursing bottle comprises a bottle body having a top opening and a bottom opening, a first nipple attached to the top opening of the bottle body and suspending outside the bottle body, a top cap fastened to the top opening of the bottle body to hold down the first nipple in place, a second nipple attached to the bottom opening of the bottle body and suspending inside the bottle body, and a bottom cap fastened to the bottom opening of the bottle body to hold down the second nipple in place.

### BRIEF DESCRIPTION OF THE DRAWINGS

FIG. 1 is an exploded view of a dual opening nursing bottle in accordance with a first embodiment of the present invention.

FIG. 2 is a schematic sectional view of a part of the dual opening nursing bottle in accordance with the first embodiment of the present invention, showing a fluid contained in the bottle body and the one-way air valve closed.

FIG. 3 is a schematic sectional view of the first embodiment of the present invention, showing the dual opening nursing bottle tilted and the one-way air valve opened.

FIG. 4 is an elevational view of a part of the dual opening nursing bottle in accordance with the first embodiment of the present invention, showing the structure of the one-way valve.

FIG. 5 is a schematic drawing of a part of a second embodiment of the present invention, showing the connection arrangement between the one-way valve and the pad.

FIG. 6 is an exploded view of a dual opening nursing bottle in accordance with a third embodiment of the present invention.

FIG. 7 is a schematic sectional view of a part of a dual opening nursing bottle in accordance with a fourth embodiment of the present invention.

FIG. 8 corresponds to FIG. 7, showing the bottle body tilted, outside air drawn through the one-way air valve into the inside of the bottle body.

FIG. 9 is a schematic sectional view of a part of a dual opening nursing bottle in accordance with a fifth embodiment of the present invention.

FIG. 10 corresponds to FIG. 9, showing the bottle body tilted, outside air drawn through the one-way air valve into the inside of the bottle body.

FIG. 11 is an exploded view of a dual opening nursing bottle in accordance with a sixth embodiment of the present invention.

FIG. 12 is a schematic sectional assembly view of the dual opening nursing bottle in accordance with the sixth embodiment of the present invention.

FIG. 13 is a sectional view of a nursing bottle according to the prior art.

FIG. 14 is a schematic sectional view showing a status of use of the nursing bottle according to the prior art.

### DETAILED DESCRIPTION OF THE PREFERRED EMBODIMENT

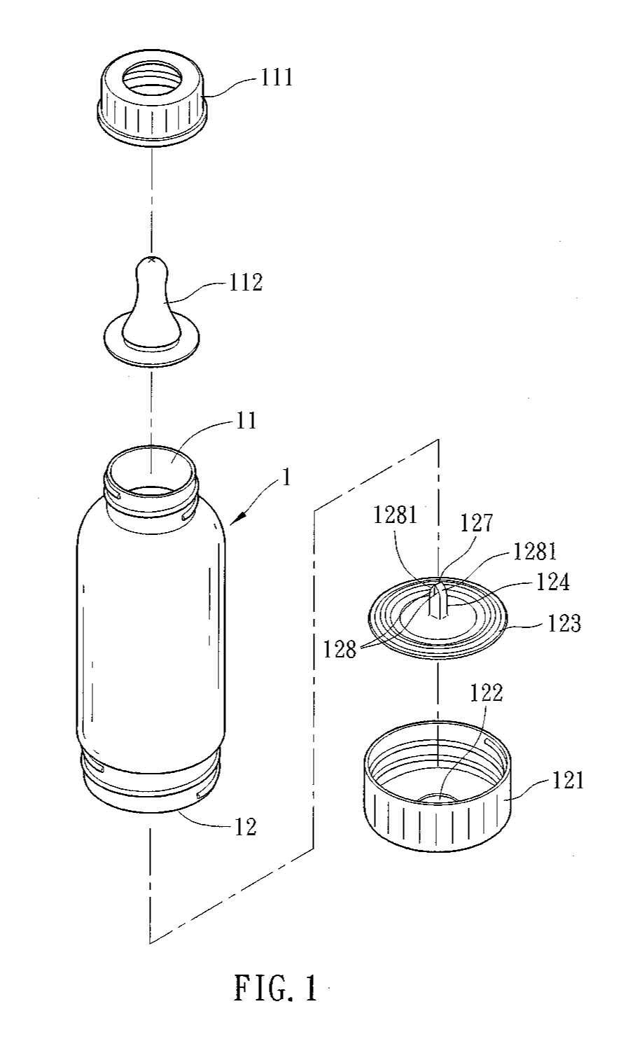

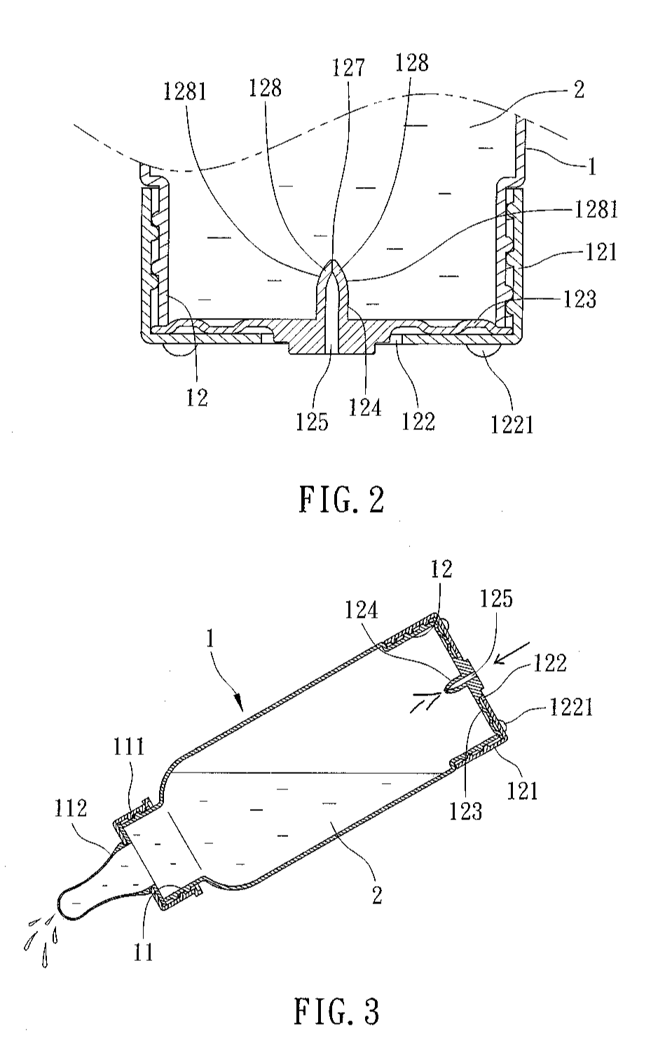

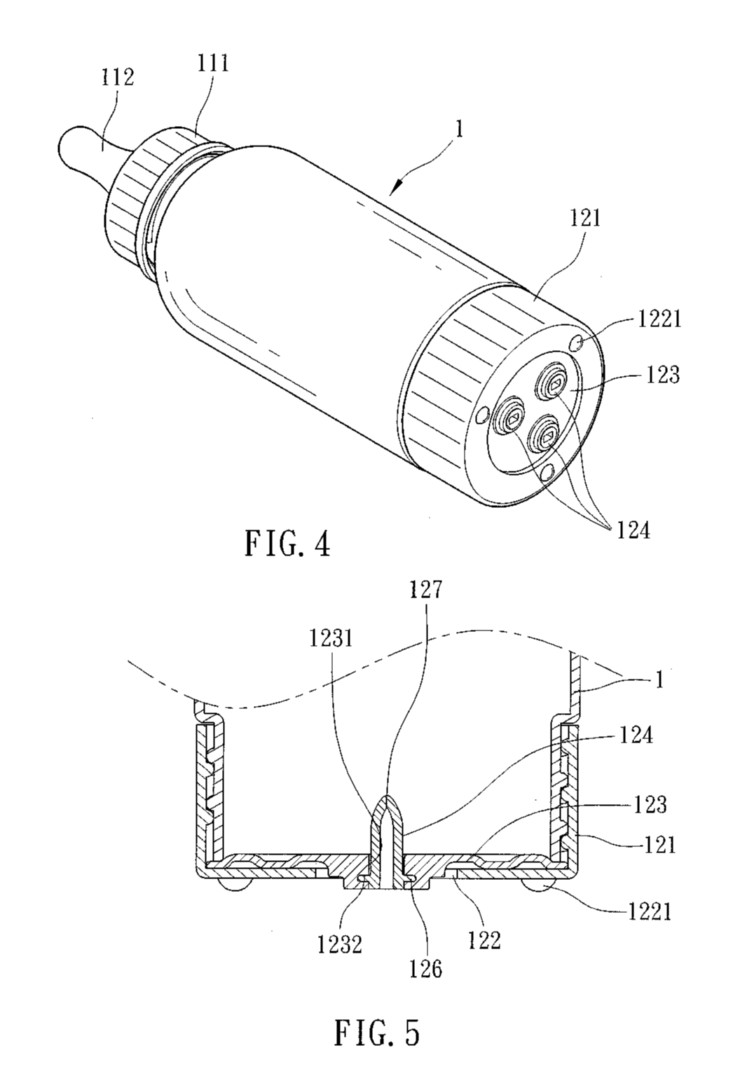

Referring to FIGS. 1-3, a dual opening nursing bottle in accordance with a first embodiment of the present invention is shown comprising a bottle body 1 having a top opening 11 and a bottom opening 12 respectively located on the top and bottom sides thereof, a nipple 112 attached to the top opening 11 of the bottle body 1 and suspending outside the bottle body 1, a top cap 111 fastened to the top opening 11 of the bottle body 1 by means of, for example, a screw joint, to hold down the nipple 112 in place, a bottom cap 121 having a center through hole 122 fastened to the bottom opening 12 of the bottle body 1 by means of, for example, a screw joint, a pad 123 mounted inside the bottom cap 121 and at least one one-way air valve 124 installed in the pad 123 for allowing outside air to pass through the center through hole 122 of the bottom cap 121 into the inside of the bottle body 1 and prohibiting flowing of inside milk out of the bottle body 1 through the center through hole 122 of the bottom cap 121. The pad 123 and the one-way air valve 124 are made from rubber or silicon rubber for the advantage of excellent elastic material property. According to this embodiment, as shown in FIG. 4, three one-way air valves 124 are installed in the pad 123. Each one-way air valve 124 has a valve flap 128 defining therein a vertically extending cylindrical blind hole 125 in air communication with the atmosphere and a split 127 formed in the valve flap 128 at the top side of the vertically extending cylindrical blind hole 125 between two flat wall portions 1281 of the valve flap 128. When the bottle body 1 is filled with a fluid (such as water, milk or beverage), the pressure of the contained fluid forces the two flat wall portions 1281 of the valve flap 128 against each other, thereby closing the split 127, and therefore the fluid does not leak out of the bottle body 1 through the vertically extending cylindrical blind hole 125 of the valve flap 128 of the one-way air valve 124. When the bottle body 1 is tilted and the baby is sucking in the fluid 2 through the nipple 112, the two flat wall portions 1281 of the valve flap 128 are released from the pressure of the fluid 2, allowing the suction force to draw outside air into the inside of the bottle body 1 through the vertically extending cylindrical blind hole 125 and the split 127, keeping the pressure inside the bottle body 1 in balance with the atmospheric pressure and facilitating the baby's suction action. Further, when cleaning the dual opening nursing bottle, the user can remove the top cap 111 and the bottom cap 121 from the top opening 11 and bottom opening 12 of the bottle body 1. Thus, the user can clean every component part of the dual opening nursing bottle thoroughly.

FIG. 5 is a schematic drawing of a part of a second embodiment of the present invention, showing the connection arrangement between the one-way valve and the pad. As illustrated, the one-way air valve 124 and the pad 123 according to this second embodiment are separately made and then fastened together by means of forcing an outside annular flange 126 of the one-way air valve 124 into engagement with an inside annular groove 1232 in the pad 123.

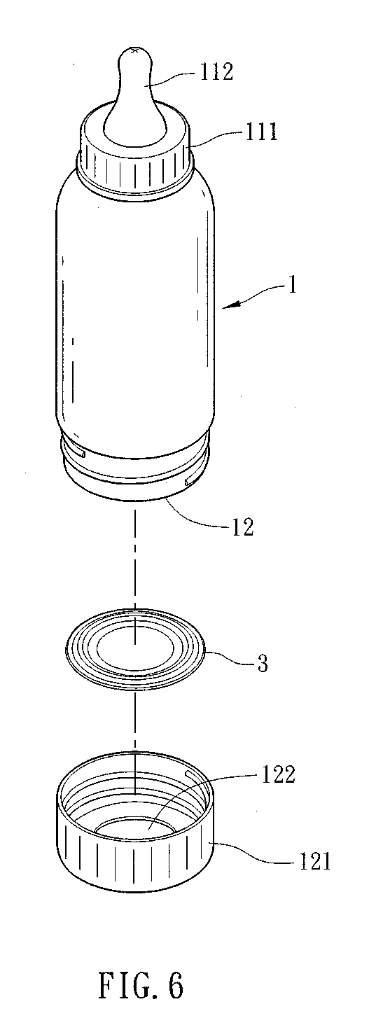

FIG. 6 is an exploded view of a dual opening nursing bottle in accordance with a third embodiment of the present invention. According to this third embodiment, the dual opening nursing bottle comprises a bottle body 1 having a top opening 11 and a bottom opening 12 respectively located on the top and bottom sides thereof, a nipple 112 attached to the top opening 11 of the bottle body 1, a top cap 111 fastened to the top opening 11 of the bottle body 1 to hold down the nipple 112 in place, a bottom cap 121 having a center through hole 122 fastened to the bottom opening 12 of the bottle body 1 and a seal pad 3 detachably mounted inside the bottom cap 121 to seal the center through hole 122 of the bottom cap 121.

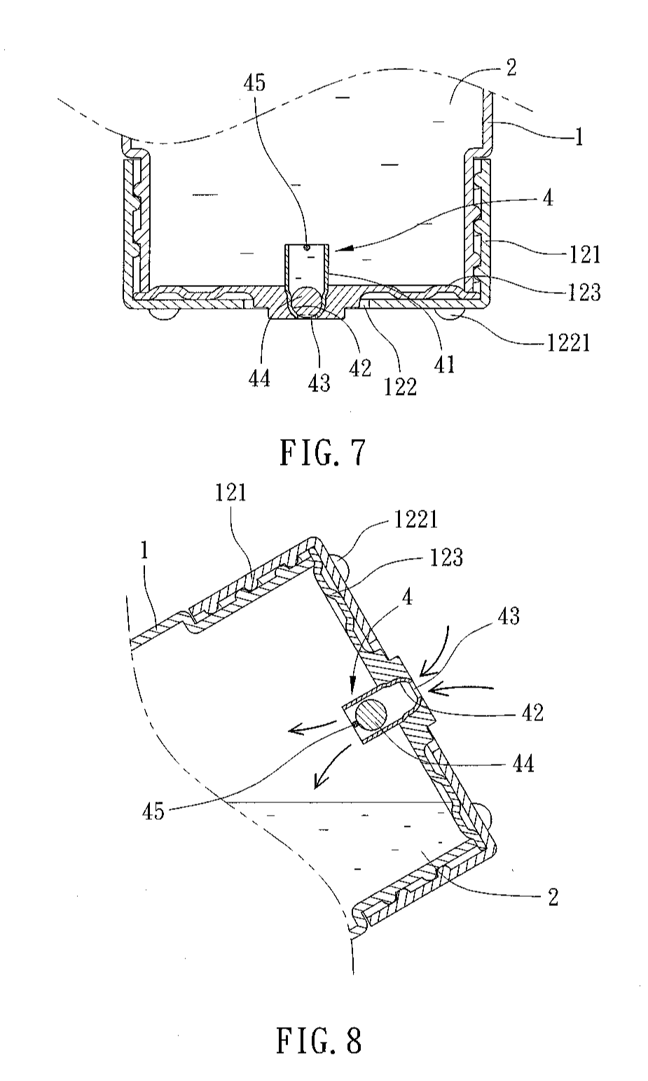

FIGS. 7 and 8 illustrate a dual opening nursing bottle in accordance with a fourth embodiment of the present invention. This fourth embodiment is substantially similar to the aforesaid first embodiment with the exception of the structure of the one-way air valve. According to this fourth embodiment, the one-way air valve, referenced by 4, comprises a tubular valve body 41 having a semispherical bottom end 42 and a hole 43 in the semispherical bottom end 42, a stop member 45 suspending in the top open side of the tubular valve body 41 and a ball 44 movably accommodated in the tubular valve body 41 and adapted for stopping the hole 43 in the semispherical bottom end 42. When the bottle body 1 holds a fluid 2 therein and is kept in vertical, the ball 44 is forced by the pressure of the fluid 2 to seal the hole 43. On the contrary, when the bottle body 1 is tilted, the ball 44 moves away from the semispherical bottom end 42 and is stopped inside the tubular valve body 41 by the stop member 45 for allowing outside air to be sucked into the inside of the bottle body 1 through the hole 43.

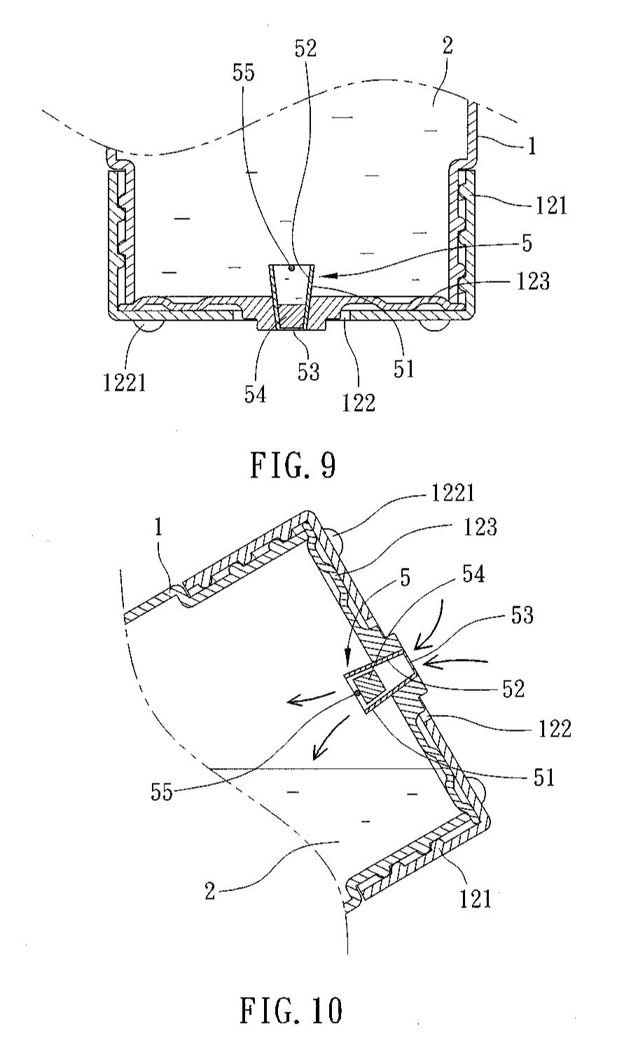

FIGS. 9 and 10 illustrate a dual opening nursing bottle in accordance with a fifth embodiment of the present invention. This fifth embodiment is substantially similar to the aforesaid first embodiment with the exception of the structure of the one-way air valve. According to this fourth embodiment, the one-way air valve, referenced by 5, comprises a valve body 51 having a conical air passage 52 extending through the top and bottom ends thereof, a stop member 55 suspending in the top open side of the conical air passage 52 and a cone 54 movably accommodated in the valve body 51 and adapted for sealing the bottom opening 53 of the conical air passage 52. When the bottle body 1 holds a fluid 2 therein and is kept in vertical, the cone 54 is forced by the pressure of the fluid 2 to seal the bottom opening 53 of the conical air passage 52. On the contrary, when the bottle body 1 is tilted, the cone 54 moves away from the bottom opening 53 of the conical air passage 52 and is stopped inside the tubular valve body 51 by the stop member 55 for allowing outside air to be sucked into the inside of the bottle body 1 through the conical air passage 52.

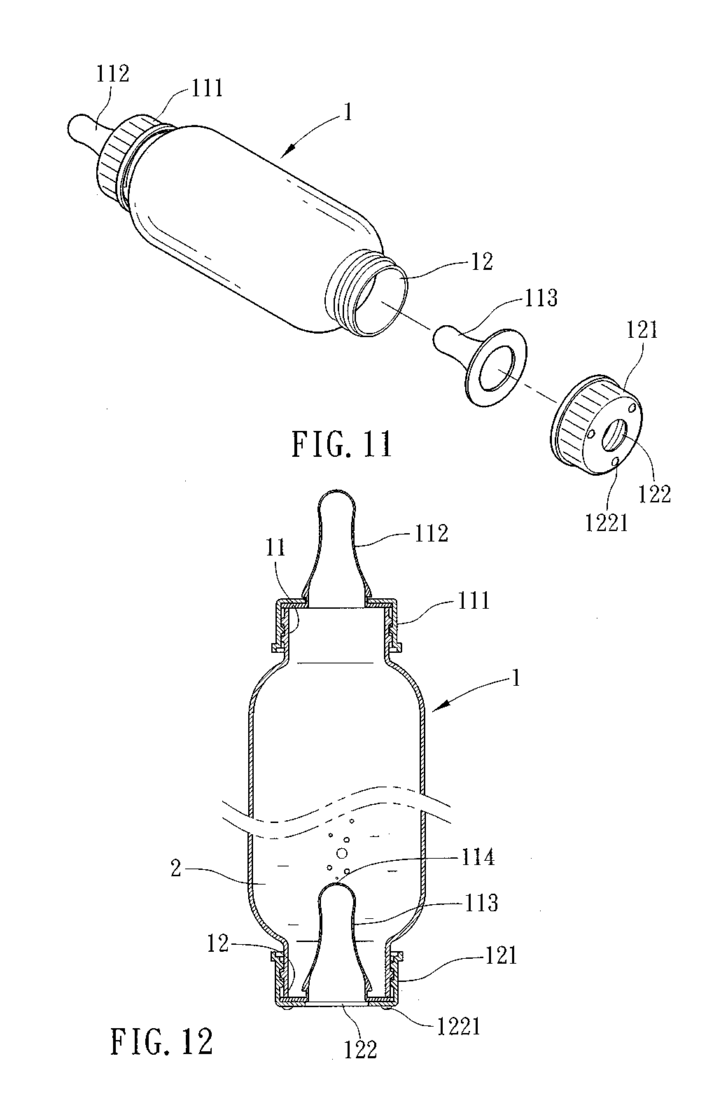

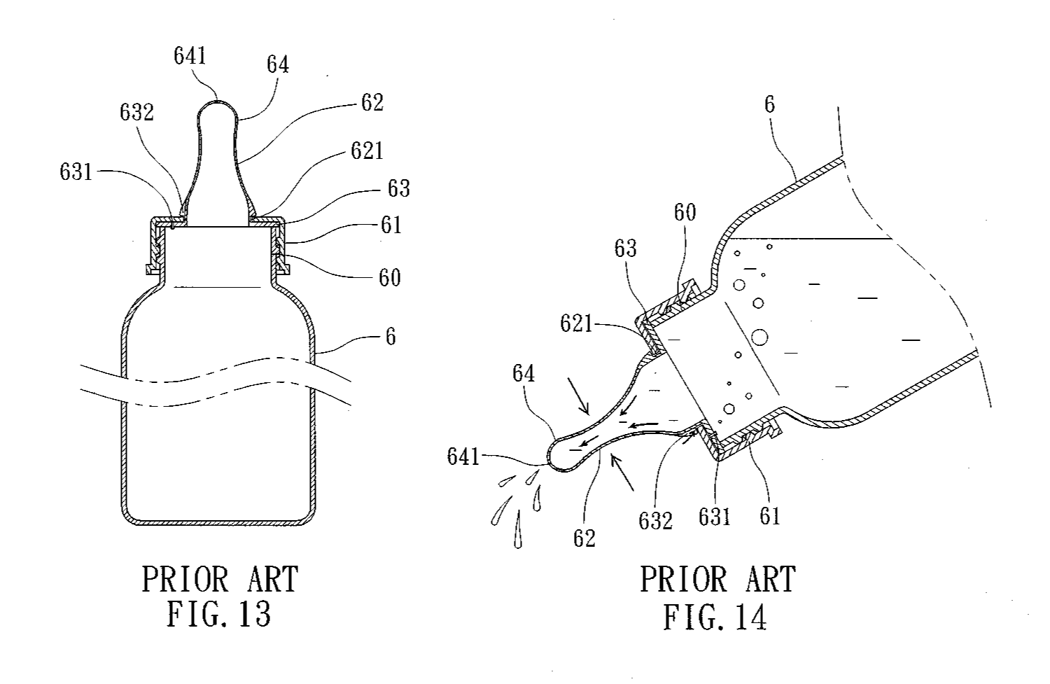

FIGS. 11 and 12 illustrate a dual opening nursing bottle in accordance with a sixth embodiment of the present invention. According to this sixth embodiment, the dual opening nursing bottle comprises a bottle body 1 having a top opening 11 and a bottom opening 12 respectively located on the top and bottom sides thereof, a first nipple 112 attached to the top opening 11 of the bottle body 1 and suspending outside the bottle body 1, a top cap 111 fastened to the top opening 11 of the bottle body 1 by means of, for example, a screw joint, to hold down the first nipple 112 in place, a second nipple 113 attached to the bottom opening 12 of the bottle body 1 and suspending inside the bottle body 1 and a bottom cap 121 fastened to the bottom opening 12 of the bottle body 1 by means of, for example, a screw joint, to hold down the second nipple 113 in place. The bottom cap 121 has a center through hole 122 and a plurality of raised portion 1221 protruded from the bottom wall and equiangularly spaced around the center through hole 122 for supporting the dual opening nursing bottle on a flat surface. When the bottle body 1 is tilted and the baby sucks the first nipple 112, outside air is sucked into the inside of the bottle body 1 through the split 114 in the top end of the second nipple 113. When wishing to clean the dual opening nursing bottle, the user can remove the top cap 111, the first nipple 112, the bottom cap 121 and the second nipple 113 from the top opening 11 and bottom opening 12 of the bottle body 1. Thus, the user can clean every component part of the dual opening nursing bottle thoroughly.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A dual opening nursing bottle, comprising:
a bottle body adapted for holding a fluid, said bottle body having a top opening and a bottom opening respectively located on top and bottom sides thereof;
a nipple attached to said top opening of said bottle body;
a top cap fastened to said top opening of said bottle body to hold down said nipple in place;
a bottom cap fastened to said bottom opening of said bottle body, said bottom cap having a center through hole;
a pad detachably mounted inside said bottom cap to seal said bottom opening of said bottle body; and
at least one one-way air valve installed in said pad for allowing outside air to be sucked into the inside of said bottle body and prohibiting a contained fluid from flowing out of said bottom body through said bottom opening.

2. The dual opening nursing bottle as claimed in claim 1, wherein each said one-way air valve has a valve flap defining therein a vertically extending cylindrical blind hole in air communication with the atmosphere, and a split formed in said valve flap at a top side of said vertically extending cylindrical blind hole between two flat wall portions of said valve flap; when said bottle body is filled with a fluid, the pressure of the contained fluid forces said two flat wall portions of said valve flap against each other to close said split; when said bottle body is tilted and said nipple is sucked by a baby, said two flat wall portions of said valve flap are released from the pressure of the contained fluid, allowing the suction force to draw outside air into the inside of said bottle body through said vertically extending cylindrical blind hole and said split.

3. The dual opening nursing bottle as claimed in claim 1, wherein each said one-way air valve is made from a material group consisting of rubber and silicon rubber.

4. The dual opening nursing bottle as claimed in claim 1, wherein each said one-way air valve is formed integral with a part of said pad.

5. The dual opening nursing bottle as claimed in claim 1, wherein said pad has an inside annular groove formed in each of at least one hole thereof; each said one-way air valve has an outside annular flange extending around the periphery thereof and forced into engagement with the respective inside annular groove of said pad.

6. The dual opening nursing bottle as claimed in claim 1, wherein said pad is a seal pad.

7. The dual opening nursing bottle as claimed in claim 1, wherein said bottom cap has a plurality of raised portions protruded from a bottom wall thereof and equiangularly spaced around said center through hole.

8. The dual opening nursing bottle as claimed in claim 1, wherein each said one-way air valve comprises a tubular valve body, said tubular valve body having a semispherical bottom end and a hole in said semispherical bottom end, a stop member suspending in a top open side of said tubular valve body and a ball movably accommodated in said tubular valve body and adapted for stopping the hole in said semispherical bottom end of said tubular valve body; when said bottle body holds a fluid therein and is kept in vertical, said ball is forced by the pressure of the contained fluid in said bottle body to seal said hole in said semispherical bottom end of said tubular valve body; when said bottle body is tilted, said ball moves away from said semispherical bottom end and is stopped inside said tubular valve body by said stop member for allowing outside air to be sucked into the inside of said valve body through the hole in said semispherical bottom end of said tubular valve body.

9. The dual opening nursing bottle as claimed in claim 1, wherein each said one-way air valve comprises a valve body, said valve body having a top open side, a bottom opening and a conical air passage extending between said top open side and said bottom opening, a stop member suspending in said top open side of said tubular valve body and a cone movably accommodated in said tubular valve body and adapted for sealing the bottom opening of said tubular valve body; when said bottle body holds a fluid therein and is kept in vertical, said cone is forced by the pressure of the contained fluid in said tubular bottle body to seal the bottom opening of said valve body; when said bottle body is tilted, said cone moves away from said bottom opening of said tubular valve boy and is stopped inside said tubular valve body by said stop member for allowing outside air to be sucked into the inside of said bottle body through said conical air passage.

10. A dual opening nursing bottle, comprising:
a bottle body adapted for holding a fluid, said bottle body having a top opening and a bottom opening respectively located on top and bottom sides thereof;
a first nipple attached to said top opening of said bottle body and suspending outside said bottle body;
a top cap fastened to said top opening of said bottle body to hold down said first nipple in place;
a second nipple attached to said bottom opening of said bottle body and suspending inside said bottle body; and
a bottom cap fastened to said bottom opening of said bottle body to hold down said second nipple in place.
